(19) United States
(12) Patent Application Publication
(10) Pub. No.: US 2006/0083140 A1
(43) Pub. Date: Apr. 20, 2006

(54) Disk apparatus and adjusting method thereof

(75) Inventor: Tomohiko Itou, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/229,504

(22) Filed: Sep. 20, 2005

(30) Foreign Application Priority Data
Oct. 14, 2004 (JP) P2004-300634

(51) Int. Cl. G11B 7/00

(52) U.S. Cl. 369/53.19; 369/44.32

(57) ABSTRACT

Only a focus servo control is operated without operating a tracking servo control and the driving voltage of a tilt coil is changed to change a tilt angle and a tilt angle is detected at which the signal level of a tracking error signal detected by an optical pick-up becomes maximum. A focus servo control and a tracking servo control are operated and the driving voltage of the tilt coil is changed to change the tilt angle. Information data recorded in an adjusting address recorded on an optical disk is read by the optical pick-up to detect a tilt angle at which the signal level of an RF signal of the read information data becomes maximum. The tilt angle of the optical pick-up is adjusted to an intermediate tilt angle between the tilt angle at which the signal level of the tracking error signal becomes maximum and the tilt angle at which the signal level of the RF signal becomes maximum.

### BACKGROUND OF THE INVENTION

1. Field of the Invention

The present invention relates to a disk apparatus for reproducing information data recorded on an optical disk, and more particularly to a disk apparatus and an adjusting method for a disk apparatus in which a recording surface of the optical disk is irradiated with a laser beam by an optical pick-up and a reflected light thereof is detected to optically read the information data recorded on the optical disk.

2. Description of the Related Art

Usually, when information data recorded on an optical disk is reproduced, the tracking servo control of an optical pick-up is not operated and only a focus servo control is operated to adjust a tilt angle of the optical pick-up so that the signal level of a tracking error signal detected by the optical pick-up becomes maximum. However, when the tilt angle of the optical pick-up is adjusted so that the signal level of the tracking error signal is maximum, the error rate of an RF signal read from the optical disk by the optical pick-up does not become minimum and the tilt angle is adjusted to a part in the vicinity of an edge in which the error rate of the RF signal as error characteristics of the RF signal is large. Thus, the reproducing quality of the information data recorded on the optical disk is undesirably deteriorated. Further, when the information data is recorded on the optical disk, if the tilt angle of the optical pick-up is not adjusted in an optimum state, the spot of a laser beam outputted from the optical pick-up is not restricted to a round form. The spot of the laser beam is formed in an elliptical form so that the power of the laser beam is insufficient and the recording quality of the information data is undesirably deteriorated.

There has been a background art in which only a focus servo control is operated to detect a tracking error signal, detect tilt information from the detected tracking error signal and adjust a tilt to zero, and then, the tilt angle of an optical pick-up is adjusted by using an adjusted value as a reference value (for instance, see JP-A-2004-95184).

Further, there has been a related art in which a tracking servo control is not operated and a rough adjustment of an angle of skew of an inclination of an optical disk is carried out on the basis of the amplitude of a reproduced RF signal, and when the amplitude of the RF signal reaches a prescribed level by the rough adjustment, the tracking servo control is operated to perform a fine adjustment of the angle of skew of the inclination of the optical disk on the basis of the phase error of the RF signal (for instance, see JP-A-2000-311370).

### SUMMARY OF THE INVENTION

However, in JP-A-2004-95184, only the focus servo control is operated to detect a tracking error signal, detect tilt information from the detected tracking error signal and adjust the tilt to zero, and then, the tilt angle of the optical pick-up can be adjusted by using the adjusted value as the reference value. However, in the background art, the tilt angle is adjusted in accordance with the tracking error signal and the above-described problems are not solved.

Further, in t JP-A-2000-311370, the tracking servo control is not operated and the rough adjustment of the angle of skew of the inclination of the optical disk is carried out on the basis of the amplitude of the reproduced RF signal, and when the amplitude of the RF signal reaches a prescribed level by the rough adjustment, the tracking servo control can be operated to perform a fine adjustment of the angle of skew of the inclination of the optical disk on the basis of the phase error of the RF signal. However, in the related art, the angle of skew of the inclination of the optical disk is adjusted by the reproduced RF signal and the above-described problems are not solved.

It is an object of the present invention to provide a disk apparatus and an adjusting method for a disk apparatus in which the tilt angle of an optical pick-up can be adjusted to a tilt angle at which the error rate of an RF signal read from an optical disk by the optical pick-up becomes minimum.

According to an aspect of the invention, there is provided a disk apparatus including: an optical pick-up for recording information data on an optical disk; a driving circuit driving a tilt coil for adjusting a tilt angle of the optical pick-up; a first detecting unit changing a driving voltage of the tilt coil by the driving circuit to change the tilt angle, when the first detecting unit operates only a focus servo control without operating a tracking servo control, and the first detecting unit detecting a tilt angle at which a signal level of a tracking error signal detected by the optical pick-up is maximum; a second detecting unit changing a driving voltage of the tilt coil by the driving circuit to change the tilt angle when the second detecting unit operates the focus servo control and the tracking servo control, and the second detecting unit reading the information data recorded in an adjusting address recorded on the optical disk by the optical pick-up, and the second detecting unit detecting a tilt angle at which the signal level of an RF signal of the read information data is maximum; and an adjusting unit adjusting the tilt angle of the optical pick-up to an intermediate tilt angle between the tilt angle detected by the first detecting unit and the tilt angle detected by the second detecting unit, and adjusting the tilt angle of the optical pick-up to a tilt angle obtained by adding a prescribed offset value to the tilt angle detected by the first detecting unit when the adjusting address is not recorded on the optical disk.

The tilt angle of the optical pick-up can be adjusted to a tilt angle at which the error rate of the RF signal read from the optical disk by the optical pick-up becomes minimum by these units.

According to the above-aspect of the invention, only a focus servo control is operated without operating a tracking servo control and the driving voltage of the tilt coil is changed to change the tilt angle and a tilt angle is detected at which the signal level of a tracking error signal detected by the optical pick-up becomes maximum. The focus servo control and the tracking servo control are operated and the driving voltage of the tilt coil is changed to change the tilt angle. The information data recorded in an adjusting address recorded on the optical disk is read by the optical pick-up to detect a tilt angle at which the signal level of an RF signal of the read information data becomes maximum. The tilt angle of the optical pick-up is adjusted to an intermediate tilt angle between the tilt angle at which the signal level of the tracking error signal becomes maximum and the tilt angle at which the signal level of the RF signal becomes maximum. Accordingly, the tilt angle of the optical pick-up can be adjusted to an intermediate tilt angle at which the error rate of the RF signal becomes minimum between the tilt angle at which the signal level of the tracking error signal becomes maximum and the tilt angle at which the signal level of the RF signal becomes maximum. Further, the tilt angle of the optical pick-up is adjusted to a tilt angle obtained by adding a prescribed offset value to the tilt angle at which the signal level of the tracking error signal becomes maximum when the adjusting address is not recorded on the optical disk. Thus, even when the adjusting address is not recorded on the optical disk 2, the tilt angle is offset by a prescribed amount nearer to a side in which the signal level of the RF signal becomes maximum than to the tilt angle of the optical pick-up at which the signal level of the tracking error signal becomes maximum. In such away, the tilt angle of the optical pick-up can be adjusted to a tilt angle in the vicinity of the tilt angle at which the error rate of the RF signal becomes minimum. According to another aspect of the invention, there is provided with an disk apparatus including: an optical pick-up for recording information data on an optical disk; a driving circuit driving a tilt coil for adjusting a tilt angle of the optical pick-up; a first detecting unit changing a driving voltage of the tilt coil by the driving circuit to change the tilt angle, when the first detecting unit operates a focus servo control without operating a tracking servo control, and the first detecting unit detecting a tilt angle at which a signal level of a tracking error signal detected by the optical pick-up is maximum; a second detecting unit changing a driving voltage of the tilt coil by the driving circuit to change the tilt angle when the second detecting unit operates the focus servo control and the tracking servo control, the second detecting unit reading the information data recorded in an adjusting address recorded on the optical disk by the optical pick-up, and the second detecting unit detecting a tilt angle at which the signal level of an RF signal of the read information data is maximum; and an adjusting unit adjusting the tilt angle of the optical pick-up to an intermediate tilt angle between the tilt angle detected by the first detecting unit and the tilt angle detected by the second detecting unit.

According to the above-aspect of the invention, only a focus servo control is operated without operating a tracking servo control and the driving voltage of the tilt coil is changed to change the tilt angle and a tilt angle is detected at which the signal level of a tracking error signal detected by the optical pick-up becomes maximum. The focus servo control and the tracking servo control are operated and the driving voltage of the tilt coil is changed to change the tilt angle. The information data recorded in an adjusting address recorded on the optical disk is read by the optical pick-up to detect a tilt angle at which the signal level of an RF signal of the read information data becomes maximum. The tilt angle of the optical pick-up is adjusted to an intermediate tilt angle between the tilt angle at which the signal level of the tracking error signal becomes maximum and the tilt angle at which the signal level of the RF signal becomes maximum. Accordingly, the tilt angle of the optical pick-up can be adjusted to an intermediate tilt angle at which the error rate of the RF signal becomes minimum between the tilt angle at which the signal level of the tracking error signal becomes maximum and the tilt angle at which the signal level of the RF signal becomes maximum.

According to another aspect of the invention, when the adjusting address is not recorded on the optical disk, the adjusting unit adjusts the tilt angle of the optical pick-up to a tilt angle obtained by adding a prescribed offset value to the tilt angle detected by the first detecting unit.

According to the above-aspect of the invention, the tilt angle of the optical pick-up is adjusted to a tilt angle obtained by adding a prescribed offset value to the tilt angle at which the signal level of the tracking error signal becomes maximum when the adjusting address is not recorded on the optical disk. Thus, even when the adjusting address is not recorded on the optical disk 2, the tilt angle is offset by a prescribed amount nearer to a side in which the signal level of the RF signal becomes maximum than to the tilt angle of the optical pick-up 3 at which the signal level of the tracking error signal becomes maximum. In such a way, the tilt angle of the optical pick-up can be adjusted to a tilt angle in the vicinity of the tilt angle at which the error rate of the RF signal becomes minimum.

According to another aspect of the invention, there is provided an adjusting method for a disk apparatus for reproducing information data recorded on an optical disk by an optical pick-up, including: changing the driving voltage of the tilt coil of the optical pick-up to change a tilt angle when only a focus servo control is operated without operating a tracking servo control; detecting a tilt angle at which the signal level of a tracking error signal detected by the optical pick-up becomes maximum; changing the driving voltage of the tilt coil of the optical pick-up to change the tilt angle on the condition that the focus servo control and the tracking servo control are operated, reading the information data recorded in an adjusting address recorded on the optical disk by the optical pick-up and detecting a tilt angle at which the signal level of an RF signal of the read information data becomes maximum; and adjusting the tilt angle of the optical pick-up to an intermediate tilt angle between the tilt angle at which a signal level of the tracking error signal becomes maximum and the tilt angle at which the signal level of the RF signal becomes maximum.

In an adjusting method according to the above-aspect of the invention, only a focus servo control is operated without operating a tracking servo control and the driving voltage of the tilt coil is changed to change the tilt angle and a tilt angle is detected at which the signal level of a tracking error signal detected by the optical pick-up becomes maximum. The focus servo control and the tracking servo control are operated and the driving voltage of the tilt coil is changed to change the tilt angle. The information data recorded in an adjusting address recorded on the optical disk is read by the optical pick-up to detect a tilt angle at which the signal level of an RF signal of the read information data becomes maximum. The tilt angle of the optical pick-up is adjusted to an intermediate tilt angle between the tilt angle at which the signal level of the tracking error signal becomes maximum and the tilt angle at which the signal level of the RF signal becomes maximum. Accordingly, the tilt angle of the optical pick-up can be adjusted to an intermediate tilt angle at which the error rate of the RF signal becomes minimum between the tilt angle at which the signal level of the tracking error signal becomes maximum and the tilt angle at which the signal level of the RF signal becomes maximum.

According to another aspect of the invention, there is provided the above-method further including; adjusting the tilt angle of the optical pick-up to a tilt angle obtained by adding a prescribed offset value to the tilt angle at which the signal level of the tracking error signal becomes maximum when the adjusting address is not recorded on the optical disk.

In an adjusting method for a disk apparatus according to the above-aspect of the invention, the tilt angle of the optical pick-up is adjusted to a tilt angle obtained by adding a prescribed offset value to the tilt angle at which the signal level of the tracking error signal becomes maximum when the adjusting address is not recorded on the optical disk. Thus, even when the adjusting address is not recorded on the optical disk 2, the tilt angle is offset by a prescribed amount nearer to a side in which the signal level of the RF signal becomes maximum than to the tilt angle of the optical pick-up 3 at which the signal level of the tracking error signal becomes maximum. In such a way, the tilt angle of the optical pick-up can be adjusted to a tilt angle in the vicinity of the tilt angle at which the error rate of the RF signal becomes minimum.

### BRIEF DESCRIPTION OF THE DRAWINGS

FIG. 1 is a block diagram showing the structure of a disk apparatus of one embodiment of the present invention.

FIG. 2 is a schematic circuit diagram showing a four-divided photo-detector of an optical pick-up and an RF amplifying circuit of a disk apparatus of one embodiment of the present invention.

FIG. 3 is an explanatory view showing a relation between an error rate of an RF signal, a signal level of a tracking error signal and a signal level of the RF signal relative to a tilt angle of the optical pick-up of the disk apparatus of one embodiment of the present invention.

FIG. 4 is a flowchart showing an operation of the disk apparatus of one embodiment of the present invention.

### DESCRIPTION OF THE RELATED ART

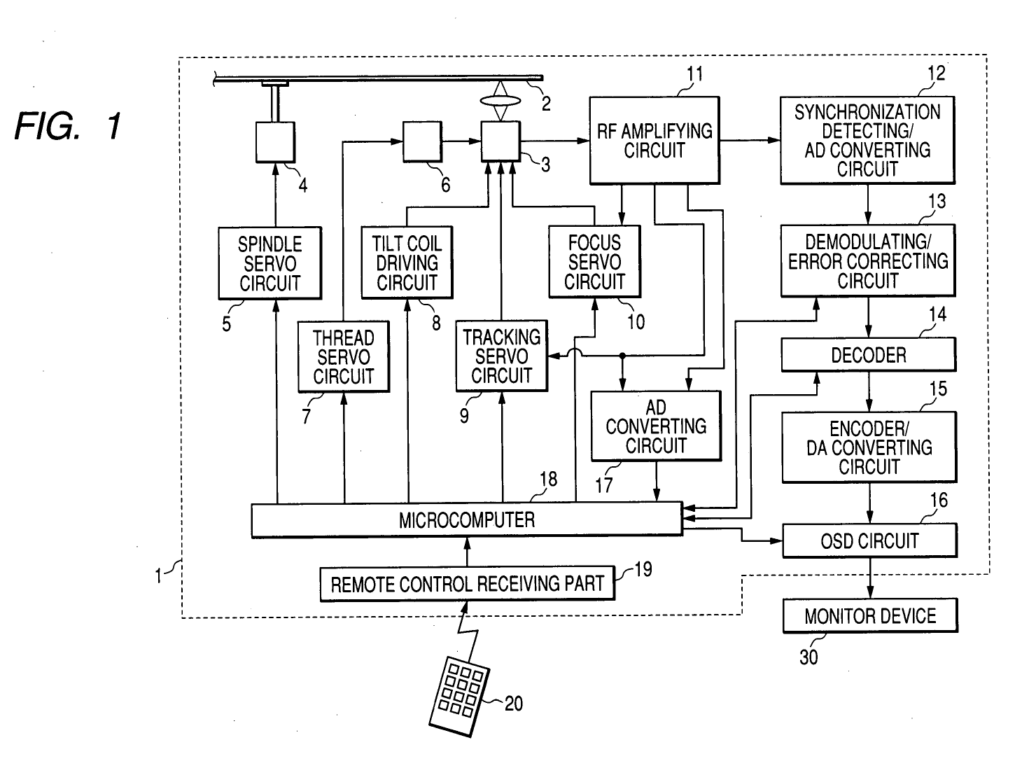

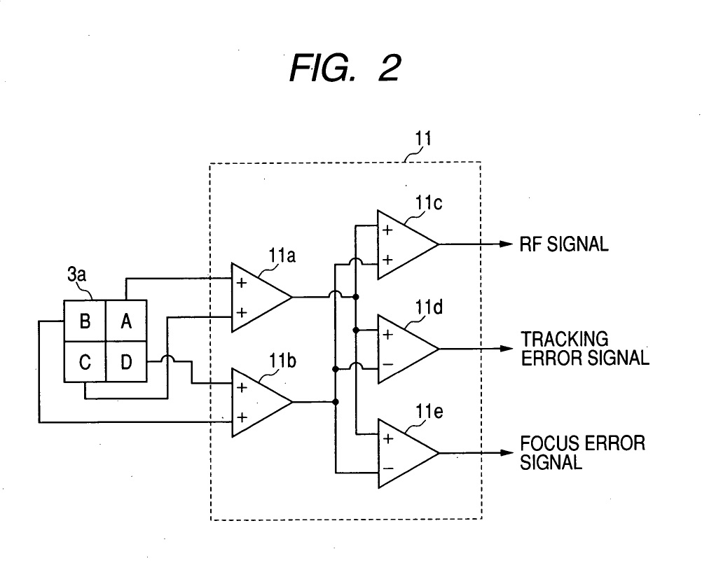

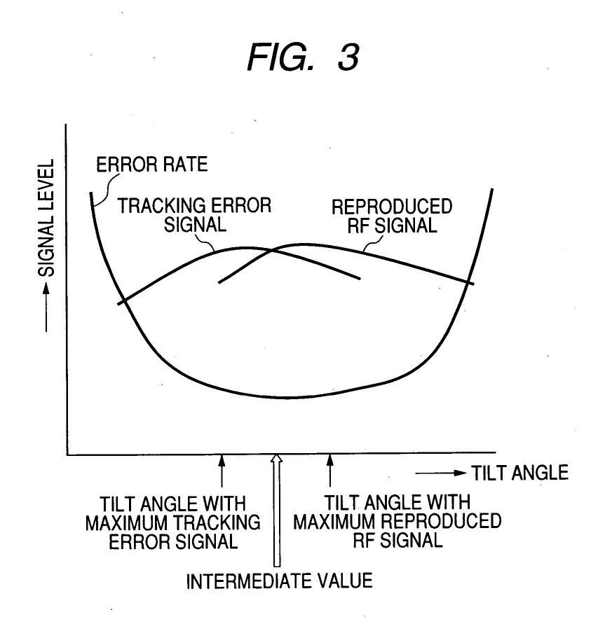

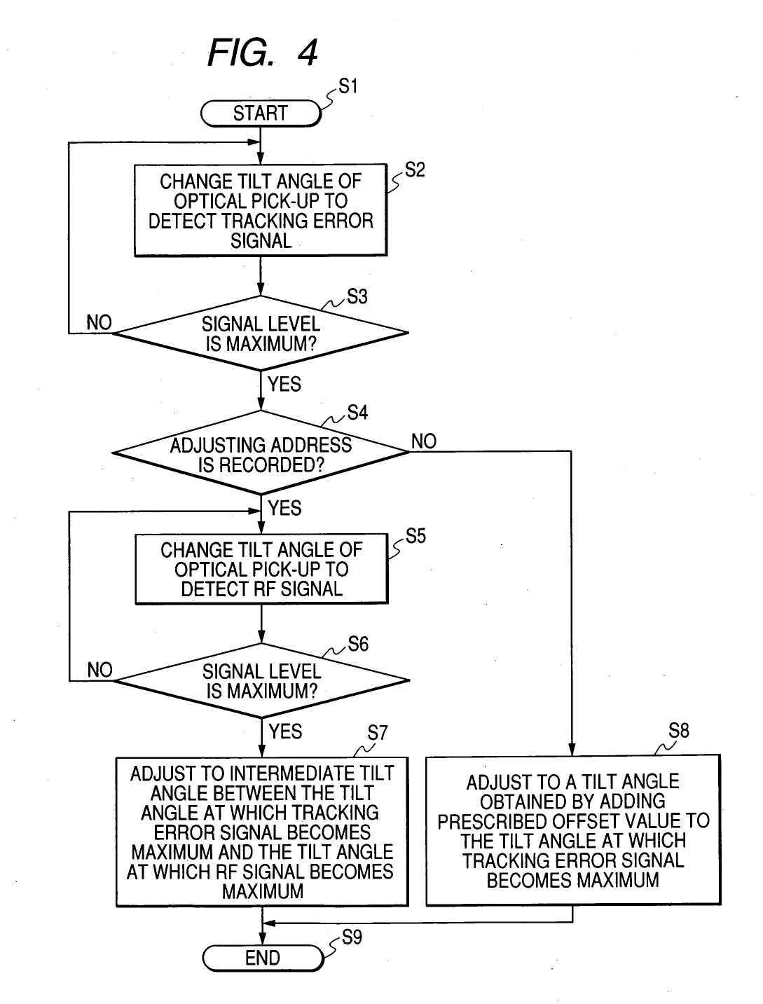

Now, an embodiment will be described in detail by properly referring to the drawings. FIG. 1 is a block diagram showing the structure of a disk apparatus according to the embodiment. FIG. 2 is a schematic circuit diagram showing a four-divided photo-detector of an optical pick-up and an RF amplifying circuit of a disk apparatus of the embodiment. FIG. 3 is an explanatory view showing a relation between an error rate of an RF signal, a signal level of a tracking error signal and a signal level of the RF signal relative to a tilt angle of the optical pick-up of the disk apparatus according to the embodiment. FIG. 4 is a flowchart showing an operation of the disk apparatus according to the embodiment.

Firstly, the embodiment will be described on the basis of the block diagram showing the structure of the disk apparatus of the embodiment. The disk apparatus 1 includes an optical pick-up 3 that applies a laser beam to an optical disk 2 to detect a reflected light thereof and read information data recorded on the optical disk 2, a spindle motor 4 for rotating the optical disk 2, a spindle servo circuit 5 for driving the spindle motor 4 to servo-control the rotating speed of the optical disk 2 to prescribed rotating speed, a thread motor 6 for moving the optical pick-up 3 in the radial direction of the optical disk 2, a thread servo circuit 7 for servo-controlling the rotating direction and the rotating speed of the thread motor 6, a tilt coil driving circuit 8 for driving the tilt coil (not shown in the drawing) of the optical pick-up 3 by a digital signal to adjust a tilt angle of the optical pick-up 3, a tracking servo circuit 9 for servo-controlling a tracking of the optical pick-up 3 on the basis of a tracking error signal detected by the optical pick-up 3, a focus servo circuit 10 for servo-controlling the focusing of the optical pick-up 3 on the basis of a focus error signal detected by the optical pick-up 3, an RF amplifying circuit 11 for amplifying an RF signal of information data read by the optical pick-up 3, a synchronization detecting/AD converting circuit 12 for synchronously detecting the RF signal amplified by the RF amplifying circuit on the basis of a reference clock and converting the RF signal of an analog signal to a digital signal, a demodulating/error correcting circuit 13 for demodulating the information data from the RF signal converted to the digital signal and correcting the error of the demodulated information data, a decoder 14 for expanding the information data compressed in accordance with a prescribed compressing system and decoding the information data to original information data, an encoder/DA converting circuit 15 for encoding the decoded information data to a video and audio signal of a composite signal in accordance with a prescribed signal system, for instance, a video and audio signal of an NTSC (National television System Committee) system and converting the encoded video and audio signal to a video and audio signal of an analog signal, an OSD (On-Screen Character Display) circuit 16 for superimposing a character information signal on a video signal to display character information on a screen of a monitor device 30, an AD converting circuit 17 for converting the tracking error signal of an analog signal detected by the optical pick-up 3 and the RF signal of the analog signal amplified by the RF amplifying circuit 11 to digital signals, a microcomputer 18 for controlling the entire part of the system of the disk apparatus 1 and a remote control receiving part 19 for receiving a remote control signal of an infrared ray signal transmitted from a remote controller 20 to convert the remote control signal to a prescribed electric signal.

Further, the optical pick-up 3 includes a four-divided photo-detector 3a as shown in FIG. 2. Detecting signals A, B, C and D respectively detected by detecting elements of the four-divided photo-detector 3a are respectively outputted. In the RF signals, signals A+C and B+D added and amplified respectively by adders and amplifiers 11a and 11b of the RF amplifying circuit 11 are added and amplified by an adder and amplifier 11c and detected as a signal of A+C+B+D. In a tracking signal, the signals A+C and B+D added and amplified respectively by the adders and amplifiers 11a and 11b of the RF amplifying circuit 11 are differentially amplified by an adder and amplifier 11d and detected as a signal of A+C−(B+D). In a focus signal, the signals A+C and B+D added and amplified respectively by the adders and amplifiers 11a and 11b of the RF amplifying circuit 11 are differentially amplified by an adder and amplifier 11e and detected as a signal of A+C−(B+D).

Now, an operation of the disk apparatus constructed as described above will be described below.

When the optical disk 2 loaded on the disk apparatus 1 is instructed to be reproduced in accordance with an operation of an operating key (not shown in the drawing) of the remote controller 20, the microcomputer 18 transmits a control signal to the focus servo circuit 10 without operating a tracking servo control to operate only a focus servo control, sequentially transmits a prescribed digital signal to the tilt coil driving circuit 8 to change a driving voltage for driving a tilt coil (not shown in the drawing) of the optical pick-up 3 and change a tilt angle of the optical pick-up 3 and detects the tilt angle of the optical pick-up 3 at which the signal level of a tracking error signal detected by the optical pick-up 3 becomes maximum.

When the driving voltage for driving the tilt coil (not shown in the drawing) of the optical pick-up 3 is changed and the tilt angle of the optical pick-up 3 is changed to detect the tilt angle at which the signal level of the tracking error signal becomes maximum (see FIG. 3), the microcomputer 18 discriminates whether or not an adjusting address for adjusting the tilt angle of the optical pick-up 3 is recorded on the optical disk 2. When the adjusting address for adjusting the tilt angle of the optical pick-up 3 is recorded on the optical disk 2, the microcomputer 18 transmits control signals to the tracking servo circuit 9 and the focus servo circuit 10 to operate the tracking servo control and the focus servo control, transmits a control signal to the thread servo circuit 7 to move the optical pick-up 3 to the adjusting address recorded on the optical disk 2, sequentially transmits a prescribed digital signal to the tilt coil driving circuit 8 to change the driving voltage for driving the tilt coil (not shown in the drawing) of the optical pick-up 3 and change the tilt angle of the optical pick-up 3 and detects the tilt angle of the optical pick-up 3 at which the signal level of the RF signal of the information data read from the optical disk 2 by the optical pick-up 3 becomes maximum.

Then, when the tilt angle of the optical pick-up 3 at which the signal level of the RF signal reproduced from the optical disk 2 becomes maximum is detected (see FIG. 3), the microcomputer 18 transmits a control signal to the tilt coil driving circuit 8 to adjust the tilt angle of the optical pick-up 3 to an intermediate tilt angle at which the error rate of the RF signal becomes minimum between the tilt angle of the optical pick-up 3 at which a tracking error signal becomes maximum and the tilt angle of the optical pick-up 3 at which the RF signal becomes maximum (see FIG. 3). Thus, the tilt angle of the optical pick-up can be adjusted to an intermediate tilt angle at which the error rate of the RF signal becomes minimum between the tilt angle at which the signal level of the tracking error signal becomes maximum and the tilt angle at which the signal level of the RF signal becomes maximum.

Further, when the adjusting address for adjusting the tilt angle of the optical pick-up 3 is not recorded on the optical disk 2, the microcomputer 18 adds a prescribed offset value, for instance, 8H of a hexadecimal number to a digital value of a digital signal in which the tilt angle of the optical pick-up 3 at which the signal level of the tracking error signal becomes maximum is detected and transmits the digital signal to which the offset value is added to the tilt coil driving circuit 8 to adjust the tilt angle of the optical pick-up 3 to a tilt angle in the vicinity of the tilt angle at which the error rate of the RF signal becomes minimum. Thus, even when the adjusting address is not recorded on the optical disk 2, the tilt angle is offset by a prescribed amount nearer to a side in which the signal level of the RF signal becomes maximum than to the tilt angle of the optical pick-up 3 at which the tracking error signal becomes maximum, so that the tilt angle of the optical pick-up can be adjusted to a tilt angle in the vicinity of the tilt angle at which the error rate of the RF signal becomes minimum.

Now, an operation of the disk apparatus according to the embodiment will be described by referring to a flowchart shown in FIG. 4.

When the optical disk loaded on the disk apparatus is instructed to be reproduced in accordance with an operation of the operating key of the remote controller, the procedure advances to step S2 from step S1. In the step S2, the tracking servo control is not operated and only the focus servo control is operated to change the driving voltage for driving the tilt coil and change the tilt angle of the optical pick-up. The signal level of the tracking error signal detected by the optical pick-up is detected to advance the procedure to step S3.

In the step S3, it is decided whether or not the signal level of the tracking error signal becomes maximum. When the signal level of the tracking error signal is maximum, the procedure advances to step S4. When the signal level of the tracking error signal is not maximum, the procedure returns to the step S2 to repeat the steps from the step S2.

In the step S4, it is decided whether or not the adjusting address for adjusting the tilt angle of the optical pick-up is recorded on the optical disk. When the adjusting address is recorded on the optical disk, the procedure advances to step S5. When the adjusting address is not recorded on the optical disk, the procedure advances to step S8.

In the step 5, the tracking servo control and the focus servo control are operated to change the driving voltage for driving the tilt coil of the optical pick-up and change the tilt angle of the optical pick-up. The information data recorded in the adjusting address recorded on the optical disk is read by the optical pick-up to detect the signal level of the RF signal of the information data read from the optical disk. The procedure advances to step S6.

In the step S6, it is decided whether or not the signal level of the RF signal read from the optical disk by the optical pick-up becomes maximum. When the signal level of the RF signal is maximum, the procedure advances to step S7. When the signal level of the RF signal is not maximum, the procedure returns to the step S5 to repeat the steps from the step S5.

In the step S7, the tilt angle of the optical pick-up is adjusted to the intermediate tilt angle at which the error rate of the RF signal becomes minimum between the tilt angle of the optical pick-up at which the signal level of the tracking error signal becomes maximum and the tilt angle of the optical pick-up at which the signal level of the RF signal becomes maximum. Then, the procedure advances to step S9 to finish the processes.

In the step S8, a prescribed offset value is added to the digital value of the digital signal of the driving voltage for driving the tilt coil of the optical pick-up in which the signal level of the detected tracking error signal becomes maximum. The tilt angle of the optical pick-up is adjusted to a tilt angle in the vicinity of the tilt angle of the optical pick-up at which the error rate of the RF signal becomes minimum. Then, the procedure advances to the step S9 to finish the processes.

The present invention is not limited thereto. It is to be understood that modifications or improvements thereof may be made within a scope of an ordinary knowledge of a person with ordinary skill in the art. The adjustment of the tilt angle of the optical pick-up of the disk apparatus for reproducing the information data recorded on the optical disk is described above, however, the tilt angle of the optical pick-up of a disk apparatus for recording and reproducing information data on an optical disk may be adjusted in the same manner. PS [Designation of Document] Drawing

[FIG. 1]
5. SPINDLE SERVO CIRCUIT
7. THREAD SERVO CIRCUIT
8. TILT COIL DRIVING CIRCUIT
9. TRACKING SERVO CIRCUIT
10. FOCUS SERVO CIRCUIT
11. RF AMPLIFYING CIRCUIT
12. SYNCHRONIZATION DETECTING/AD CONVERTING CIRCUIT
13. DEMODULATING/ERROR CORRECTING CIRCUIT
14. DECODER
15. ENCODER/DA CONVERTING CIRCUIT
16. OSD CIRCUIT
17. AD CONVERTING CIRCUIT
18. MICROCOMPUTER
19. REMOTE CONTROL RECEIVING PART
30. MONITOR DEVICE

[FIG. 4]
S1. START
S2. CHANGE TILT ANGLE OF OPTICAL PICK-UP TO DETECT TRACKING ERROR SIGNAL.
S3. SIGNAL LEVEL IS MAXIMUM ?
S4. ADJUSTING ADDRESS IS RECORDED ?
S5. CHANGE TILT ANGLE OF OPTICAL PICK-UP TO DETECT RF SIGNAL.
S6. SIGNAL LEVEL IS MAXIMUM ?
S7. ADJUST TO INTERMEDIATE TILT ANGLE BETWEEN THE TILT ANGLE AT WHICH TRACKING ERROR SIGNAL BECOMES MAXIMUM AND THE TILT ANGLE AT WHICH RF SIGNAL BECOMES MAXIMUM.
S8. ADJUST TOA TILT ANGLE OBTAINED BY ADDING PRESCRIBED OFFSET VALUE TO THE TILT ANGLE AT WHICH TRACKING ERROR SIGNAL BECOMES MAXIMUM.
S9. END

What is claimed is:

1. A disk apparatus comprising:
an optical pick-up for recording information data on an optical disk;
a driving circuit driving a tilt coil for adjusting a tilt angle of the optical pick-up;
a first detecting unit changing a driving voltage of the tilt coil by the driving circuit to change the tilt angle, when the first detecting unit operates only a focus servo control without operating a tracking servo control, and the first detecting unit detecting a tilt angle at which a signal level of a tracking error signal detected by the optical pick-up is maximum;
a second detecting unit changing a driving voltage of the tilt coil by the driving circuit to change the tilt angle when the second detecting unit operates the focus servo control and the tracking servo control, and the second detecting unit reading the information data recorded in an adjusting address recorded on the optical disk by the optical pick-up, and the second detecting unit detecting a tilt angle at which the signal level of an RF signal of the read information data is maximum; and
an adjusting unit adjusting the tilt angle of the optical pick-up to an intermediate tilt angle between the tilt angle detected by the first detecting unit and the tilt angle detected by the second detecting unit, and adjusting the tilt angle of the optical pick-up to a tilt angle obtained by adding a prescribed offset value to the tilt angle detected by the first detecting unit when the adjusting address is not recorded on the optical disk.

2. A disk apparatus comprising:
an optical pick-up for recording information data on an optical disk;
a driving circuit driving a tilt coil for adjusting a tilt angle of the optical pick-up;
a first detecting unit changing a driving voltage of the tilt coil by the driving circuit to change the tilt angle, when the first detecting unit operates a focus servo control without operating a tracking servo control, and the first detecting unit detecting a tilt angle at which a signal level of a tracking error signal detected by the optical pick-up is maximum;
a second detecting unit changing a driving voltage of the tilt coil by the driving circuit to change the tilt angle when the second detecting unit operates the focus servo control and the tracking servo control, the second detecting unit reading the information data recorded in an adjusting address recorded on the optical disk by the optical pick-up, and the second detecting unit detecting a tilt angle at which the signal level of an RF signal of the read information data is maximum; and
an adjusting unit adjusting the tilt angle of the optical pick-up to an intermediate tilt angle between the tilt angle detected by the first detecting unit and the tilt angle detected by the second detecting unit.

3. A disk apparatus according to claim 2, wherein when the adjusting address is not recorded on the optical disk, the adjusting unit adjusts the tilt angle of the optical pick-up to a tilt angle obtained by adding a prescribed offset value to the tilt angle detected by the first detecting unit.

4. An adjusting method for a disk apparatus for reproducing information data recorded on an optical disk by an optical pick-up, said adjusting method comprising:
changing the driving voltage of the tilt coil of the optical pick-up to change a tilt angle when only a focus servo control is operated without operating a tracking servo control;
detecting a tilt angle at which the signal level of a tracking error signal detected by the optical pick-up becomes maximum;
changing the driving voltage of the tilt coil of the optical pick-up to change the tilt angle on the condition that the focus servo control and the tracking servo control are operated,
reading the information data recorded in an adjusting address recorded on the optical disk by the optical pick-up and detecting a tilt angle at which the signal level of an RF signal of the read information data becomes maximum; and
adjusting the tilt angle of the optical pick-up to an intermediate tilt angle between the tilt angle at which a signal level of the tracking error signal becomes maximum and the tilt angle at which the signal level of the RF signal becomes maximum.

5. An adjusting method for a disk apparatus according to claim 4, further comprising:
adjusting the tilt angle of the optical pick-up to a tilt angle obtained by adding a prescribed offset value to the tilt angle at which the signal level of the tracking error signal becomes maximum when the adjusting address is not recorded on the optical disk.
